(19) United States
(12) Patent Application Publication
(10) Pub. No.: US 2012/0287198 A1
(43) Pub. Date: Nov. 15, 2012

(54) Imaging Jetted Ink

(75) Inventor: Steven H. Barss, Wilmot, NH (US)

(73) Assignee: Fujifilm Dimatix, Inc., Lebanon, NH (US)

(21) Appl. No.: 13/105,373

(22) Filed: May 11, 2011

(51) Int. Cl. B41J 29/393

(52) U.S. Cl. 347/19

(57) ABSTRACT

In general, in an aspect, a laser produces a coherent beam to illuminate ink jetted from an orifice of an inkjet, for use in imaging the jetted ink, and a device is used to reduce an effect of speckle caused by the coherent beam in the imaging of the jetted ink.

### BACKGROUND

This description relates to imaging jetted ink.

Imaging ink jetted from an orifice (also sometimes called a nozzle) of an inkjet head on its way to a substrate, for example, can be useful in designing or building the head and in defining or altering an operating protocol for jetting the ink.

### SUMMARY

The imaging of jetted ink that we describe here may be characterized by one or more of the following aspects, features, and implementations, and others.

In general, in an aspect, a laser produces a coherent beam to illuminate ink jetted from an orifice of an inkjet, for use in imaging the jetted ink, and a device is used to reduce an effect of speckle caused by the coherent beam in the imaging of the jetted ink.

Implementations may include one or more of the following features. The device to reduce the effect of speckle includes a device to render the beam at least partly incoherent. The device to reduce the effect of speckle is configured to alter an aspect of a phase of a wavefront of the coherent beam. The aspect of the phase of the wavefront that is altered is temporal or spatial or both. The device to reduce the effect of speckle includes a diffuser through which the coherent beam is to be passed.

An element is provided to reduce diffraction effects in the imaging. The element includes a lens. The lens includes a cylindrical lens. The lens has an optical axis that is roughly parallel to an axis of the jetted ink. The laser includes a Nd:YAG laser. A trigger synchronizes the coherent beam with the jetted ink. The device to reduce the effect of speckle includes a diffuser. There is also a cylindrical lens to reduce diffraction effects. The cylindrical lens includes a Fresnel lens. There is a video camera for the imaging.

A flash of the coherent beam is brief enough to permit imaging, without motion blur, of jetted ink moving at a speed of at least 10 meters/second. The laser produces the coherent beam at a brightness that permits imaging of jetted ink that has features of interest that are smaller than 3 micrometers. The imaging includes a video. The imaging includes a single image. The imaging includes a succession of images captured at a frequency of up to 15 Hz (or in some cases more than 15 Hz). The imaging includes optical magnification of up to 20 times real life (or in some cases up to 35 times real life or higher).

In general, in an aspect, ink is jetted from an orifice of an inkjet, a coherent beam from a laser is applied to the jetted ink while the jetted ink is in motion, the jetted ink is imaged while the jetted ink is in motion, and an effect of speckle caused by the coherent beam on the imaged jetted ink is reduced.

Implementations may include one or more of the following features. The reducing of the effect of speckle includes rendering the coherent beam at least partly incoherent. The reducing of the effect of speckle includes altering an aspect of a phase of a wavefront of the coherent beam. The altering includes altering a temporal or spatial aspect of the phase or both. A flash of the coherent beam is synchronized with motion of the jetted ink. The imaging includes capturing a single image or a series of images or a video. The imaging includes magnifying the jetted ink in the imaging by at least 10 times real life. A flash of the coherent beam is brief enough to permit imaging, without motion blur, of jetted ink moving at a speed of at least 10 meters/second. The coherent beam is produced at a brightness that permits imaging of jetted ink that has features of interest that are smaller than 3 micrometers.

These and other features and aspects, and combinations of them, can be expressed as systems, components, apparatus, methods, means or steps for performing functions, methods of doing business, and in other ways.

Other features, aspects, implementations, and advantages will be apparent from the description and the claims.

### DESCRIPTION

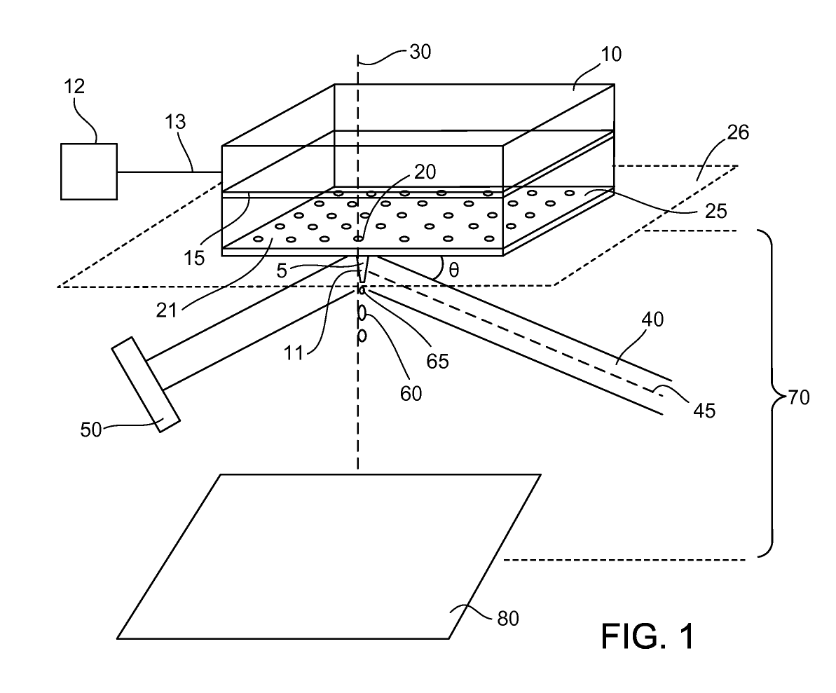

FIG. 1 is a schematic perspective view of jetting of ink.

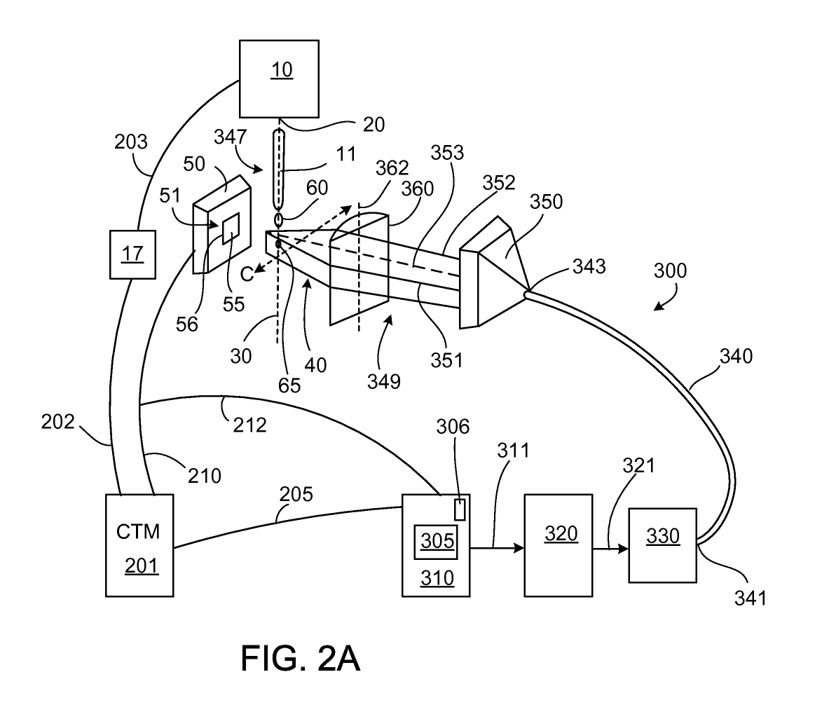

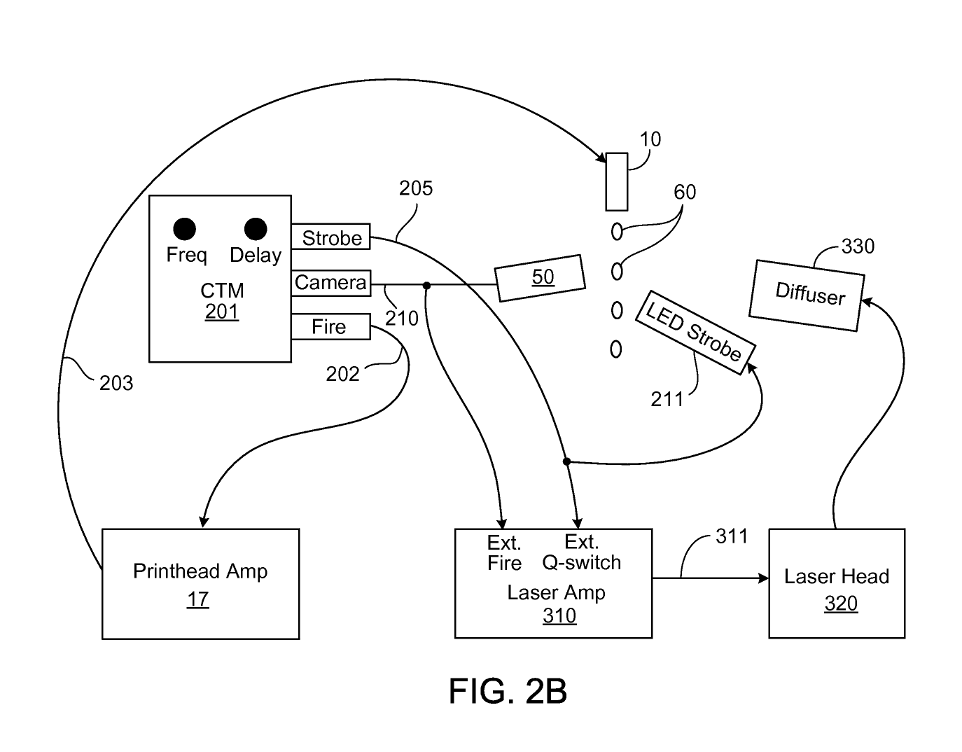

FIG. 2A is a schematic perspective view of an optical setup.

FIG. 2B is a schematic perspective view of an optical setup.

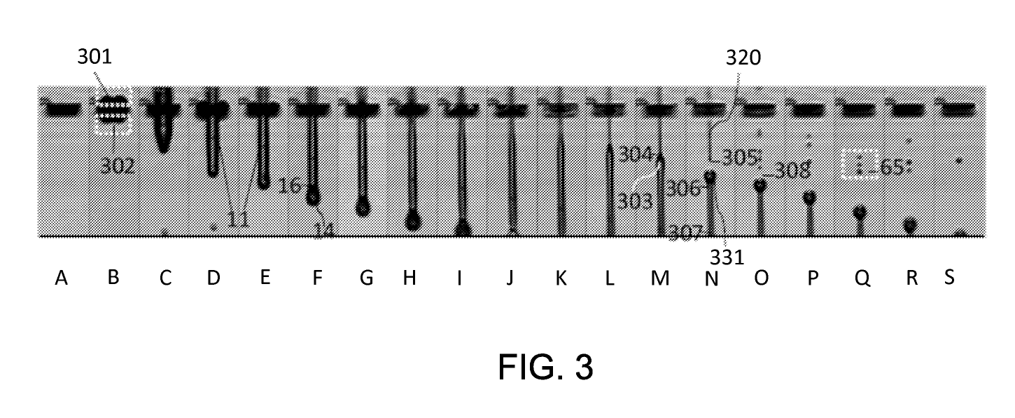

FIG. 3 is a sequence of images.

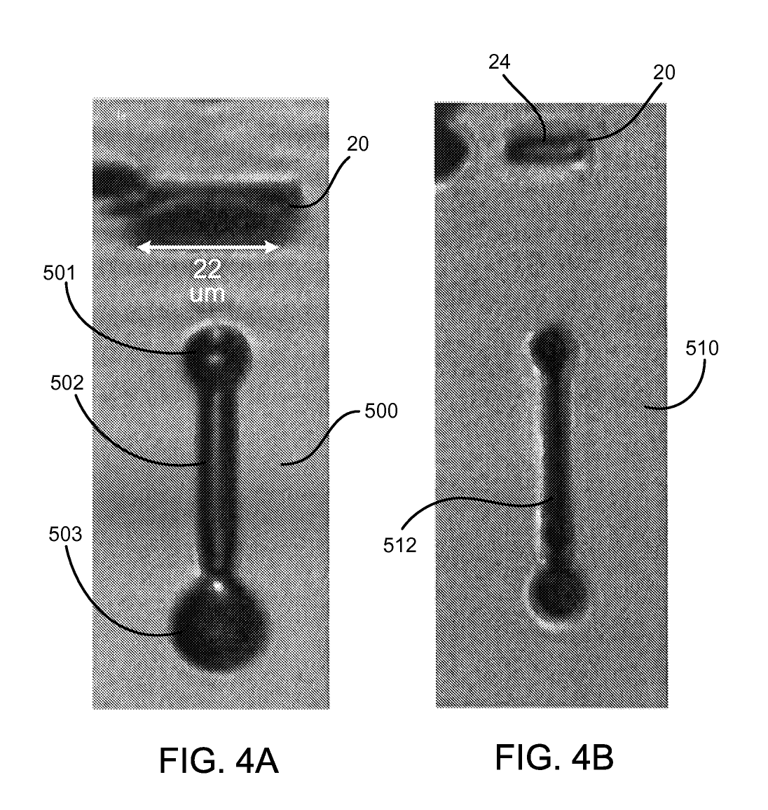

FIGS. 4A and 4B are images.

As shown in FIG. 1, during inkjet printing, ink 5 that is jetted from an orifice 20 of an orifice plate 25 of an inkjet printhead 10 (shown schematically) begins as a stream of ink 11 emanating from the orifice along a jetting axis 30. The stream quickly (within microseconds) undergoes a complicated transformation to form, for example, one or more ink drops 60 as it passes across a small gap 70 (shown out of scale in the figure) towards a target substrate 80 (e.g., paper or fabric or other medium to be printed on). Details of this transformation are shown in FIG. 3 and discussed below. We use the term ink jetting in a broad sense to refer, for example, to any propelling of liquid from a nozzle or orifice.

In some implementations, each ink drop 60 has a diameter of several micrometers (e.g., less than 30 μm, less than 20 μm, less than 10 μm, less than 5 μm) and a volume on the order of 10 picoliter (10⁻¹² l) or less, for example, about 2 picoliter). In some cases, one or more satellite droplets 65 of ink are also formed in the transformation of the stream. Each satellite droplet 65 can, for example, trail or lead the main ink drop 60. Each satellite droplet 65 may have, for example, a diameter as small as about 2 μm and a volume of several femtoliters (10⁻¹⁵ l).

The stream 11 of jetted ink, the drop 60, and the satellite droplets 65 all represent what we call jetted ink features. Other shapes, sizes, volumes, and numbers of jetted ink features may be formed in the process of jetting ink and delivering it to a substrate.

The jetting of the ink is triggered and controlled by a waveform generator 12 that sends electrical waveforms or a signal 13 to a set of actuators 15 (one for each orifice typically) as shown schematically in FIG. 1. The design and configuration of the inkjets (e.g., the geometry of the orifices, ink chambers, and actuators) and the waveform applied to the actuator 15 affect characteristics of the jetting of ink. These characteristics can include the speed at which the ink leaves the orifice, the volume of ink jetted, the shape of the stream, the number, size, shape, and volume of the jetted ink features that are formed when the ink is jetted, the transformation of the jetted ink over time as it travels toward the substrate, and other features. Among other things, satellite droplets can be eliminated or a desired ink drop profile can be obtained.

In designing, manufacturing, and operating inkjet heads and related equipment, selecting and designing inks to achieve desired characteristics in the jetting of ink, and in understanding failure modes in ink jetting (such as generation of satellite drops, jetting directionality problems, instability of drop formation, changes in drop output as a function of jetting frequency and/or a number of jets firing, jet death, and others), it is useful to generate, store, analyze, track, and use images, sequences of images, and videos of the jetted ink and the details of its evolution over the very short period of time from when it begins to be jetted to when it reaches a substrate. Jet death refers to a jet that stops functioning completely. The transition from a functioning to a non-functioning jet is sometimes observable and provides information about failure modes.

We use the term imaging very broadly to include, for example, any technique or equipment that captures images, sequences of images, video, or any other kind of visual or graphical representation at a moment in time, at a closely spaced succession of times, or at spaced apart times, and to analysis, tracking, manipulation, processing, replay, storage, combination, or separation of such visual or graphical representations.

Among other things, imaging jetted ink aids the optimizing of inkjet printhead performance, the study of drop behavior, the design of waveforms, the understanding of jetting failure modes, the study of different inkjet designs, and the evaluation of inkjet responses to input waveforms. (We use the term inkjet to include, for example, a device that has an orifice from which liquid is to be jetted and elements that respond to a waveform to cause the jetting of the liquid from the orifice, among other things.)

Imaging of jetted ink also aids studies of drop formation (e.g., tail breakup, satellite formation) and meniscus formation at the orifice. Tail breakup refers, for example, to the truncation of an ink stream at a truncation point at the trailing end of the ink stream (the portion closer to the nozzle), by which the portion of the ink stream (on the other side of the truncation point from the nozzle) coalesces to form a substantially spherical ink drop. Satellite formation refers, for example, to the formation of one or more ink droplets that are smaller than the (main) ink drop (e.g., more than twenty times smaller, more than ten times smaller, more than five times smaller, more than 2 times smaller). Because the jetted ink may move very rapidly (on the order of 25 msec) and the ink drop and other features that are formed as the jetted ink moves toward a target substrate may be very tiny (on the order of femto-liters), forming images of the jetted ink and the features requires a lot of light.

Successful imaging of tiny ink features (having sizes on the order of micrometers and volumes from several femtoliters to picoliters) requires high magnification and, in turn, relatively high light intensity.

In addition, the high speed of the jetted ink (for example, higher than 10 m/s, or 15 m/s, or 20 m/s, or 25 m/s) can produce motion blur in images that are captured using too long a period of exposure. For example, if the exposure spans the time in which an ink drop travels a distance equal to its diameter, the resulting image will exhibit motion blur (that is, a smeared image) caused by a superposition of images of the ink drop at multiple positions. This suggests a need for brief exposure times.

On the other hand, when a high speed movie or video of successive frames of jetted ink is to be captured, the camera will be operated at a high shutter rate (the number of shutter cycles per second, e.g. 50 MHz or more). Then the “shutter open” period for each frame may be too brief for satisfactory imaging of jetted ink in each frame, at least when a light source of relatively low intensity is used.

The exposure time of an image may be determined by how long the shutter of the imaging device (e.g., a digital video camera) remains open or by the duration of a flash of light used for the exposure while the shutter is open, or by a combination of them. There is a limit on how fast the mechanical or electronic shutters of movie or video cameras can close after being opened.

Even if the shortest possible shutter open time is too long to prevent motion blur, motion blur can be reduced or eliminated by using a light source that can deliver pulses or flashes of light that are briefer than the periods during which the shutter is open. The light source is pulsed repeatedly in synchronism with the successive shutter openings to generate multiple images, for example, in sequence. By using intense short flashes of light, then, it is possible to reduce motion blur and yet provide enough illumination to enable the needed degree of magnification. A 1 μm diameter ink drop traveling at 25 m/s, moves a distance equal to its diameter in 40 ns. To eliminate motion blur in the resulting image, the light source should be capable of a pulse duration of less than 40 ns.

Light emitting diodes (LEDs) can be pulsed to obtain light pulses having a pulse duration of less than 40 ns, but at a relatively low output intensity. Argon or xenon flash lamps provide high intensity light at relatively long pulse durations on the order of 200 μs (although at least one vendor makes an Argon flashlamp with a nominally 40 ns pulse duration)

Pulsed laser sources can provide both high intensity light and short pulse duration. In coherent laser light (it is coherent in that it has a specific phase relationship spatially and/or temporally with itself or with another light source), different portions of the coherent light can interfere to generate interference patterns, such as a random-intensity so-called speckle pattern, produced by mutual interference of a set of wavefronts. One way to reduce speckle is to split up the coherent light, send the split coherent light in parallel through optical elements having different optical path lengths, then recollimate the light that passed through the optical elements.

In some examples of imaging of jetted ink, a diffuser containing a fluorescent dye element is placed in the beam path of the coherent laser light to reduce or eliminate its coherence. In general, we use the term diffuser to refer, for example, to any device that diffuses or spreads out or scatters light, to yield what might be called soft light. In some examples, a fluorescent dye diffuser absorbs the coherent laser light incident on the diffuser and emits a secondary burst of non-coherent, light of a specific color that has a wavelength that is shifted relative to the incident light.

In some embodiments, a LaVision high efficiency diffuser optics (part number 1108417) is used as the diffuser. Due to the high efficiency of the diffuser, (30% conversion efficiency from 532 nm to 550-600 nm), the amount of light reaching the jetted ink remains high and imaging magnification can be, for example, as high as ten times the magnification of known systems. The diameter of output light from the LaVision high efficiency diffuser optics is 120 mm. A possible upper limit of the magnification is determined based on a minimum image contrast recorded at the imaging detector that is required for viewing and analysis of the image.

In FIG. 2, an illumination system 300 for illuminating ink jetted from an orifice (e.g., the nozzle 20) of an inkjet printhead 10 includes a laser amplifier and controller 310 connected 311 to drive and control a Nd:YAG laser 320. The laser delivers a beam 321 to a fluorescent dye diffuser 330. An optical fiber 340 is connected at one end 341 to the diffuser 330 and at another end 343 to a beam collimator 350. We use the term beam collimator to include, for example, any device that causes propagation directions of a beam to become more aligned in a direction (e.g., collimated or parallel). A collimated beam of light has, for example, rays that are nearly parallel, and therefore will spread slowly as the beam propagates.

The light 349 exiting the beam collimator 350 is not coherent and has a diameter of, say, 120 mm. This output light is focused, on the ink 347 jetted by one of the orifices, by a linear lens 360 (e.g., a cylindrical lens). In general, a lens is an optical device that transmits and refracts light, converging or diverging a beam of the light. A linear lens (e.g., a cylindrical lens) converges or diverges light only in one dimension, in this case the dimension C. In the example shown in FIG. 2, the vertical span of the focused light only covers a portion of the length of the jetted ink along the axis of jetting 30. In other arrangements, the entire length could be lit by focused illumination from a long linear lens.

The light emerging from the linear lens 360, depicted as illuminating light 40, illuminates the jetted ink feature 60. Light reflected and transmitted from the field of focused illumination is detected by a light detector 50 (e.g., a digital camera or digital video camera having a sensor 51 that captures an image of the jetted ink). In addition to recording a single image, the detector 50 can also record a sequence of images or a movie.

In some embodiments, a 532 nm laser light beam is delivered to the diffuser from a LaVision Nd:YAG Dual Cavity pulsed laser (part number 1103032) in 30 mJ pulses each having a pulse duration of 5 ns, at a repetition rate of 15 Hz. The LaVision laser includes a laser head 320 and a single power supply 306 having an integrated control panel 305.

A central timer module (CTM) 201 coordinates (synchronizes) trigger signals 205 and trigger signals 210 sent to the detector 50. Split-off signals 212 are sent to the laser amplifier and controller 310. The trigger signals 210 cause the detector 50 to open its shutter 200 μs before a flash of laser pulse is emitted from the laser head 320. This delay of 200 μs takes into account a Q-switch delay associated with the laser amplifier 310. Q-switching, is a technique by which a laser can be made to produce a pulsed output beam. The laser amplifier and controller 310 (for example, a LaVision laser) can fire each pulse based on an input (e.g., a split signal 212) derived from the CTM 201. The CTM 201 generates three signals (202, 205, and 210), the relationships of which are controlled by software, and these signals drive the inputs of the detector 50 and the power supply 306 of the laser. The trigger signals 205 (the STROBE output) are delayed relative to the signals 202 (the FIRE output) by the amount of time that one wants to observe the drop after the initiation of the signals 202 (the FIRE pulse). The trigger signals 210 (the CAMERA output) trigger the shutter of the detector 50 and also initiate the laser firing—since the Q-switching optimal time is relatively fixed, this occurs at a fixed time before the laser is Q-switched with the STROBE output (˜200 μs).

FIG. 2B differs from FIG. 2A by an LED strobe 211 that is connected to the trigger signals 205 (the STROBE output) in the same way as the laser amplifier and controller 310. In some implementations, the LED strobe 211 is used in a system that does not include a laser. In some implementations, both the laser system and the LED strobe 211 are used together when appropriate. With the LED strobe, it is also advantageous to open the shutter of the detector 50 slightly before a flash is emitted from the LED strobe 211 due to signal propagation delays in the detector 50 of a few μs. The CTM 201 also sends signals 202 to a printhead amplifier 17, which includes the waveform generator 12 (FIG. 1). The printhead amplifier 17 sends signals 203 to the printhead 10 to cause the actuator to jet ink from the nozzle 20.

At the high magnification made possible by the high efficiency of the diffuser 330 in generating the high intensity short pulses without speckle patterns, diffraction effects of the imaging optics on the images become more prominent. Diffraction effects can include halos of light around the jetted ink features. Adding the cylindrical lens 360 (e.g., in FIG. 2) in the imaging light path substantially reduces the diffraction effects observed. By aligning the axis 362 along which the cylindrical lens focuses light to be parallel to the direction 30 along which the jetted ink is moving, diffraction along the length of a drop or other jetted ink feature can be substantially reduced.

It is possible that, in using the cylindrical lens, light from the edges of the collimator 350 (having light paths 351 and 352 that are farther away from the center path 353 of the light beam) will degrade the sharpness of an edge 56 of the image 55. In general, the numerical aperture (NA) of the illumination source should match (e.g., be equal to) the NA of the camera 50 lens at the detector 50.

In some embodiments, an appropriate condenser lens (e.g., a spherical lens) instead of a cylindrical lens may be used. In some embodiments, the cylindrical lens is a Fresnel lens. In some embodiments, an Edmunds optics NT46-114 Fresnel lens with a focal length of 6 inches can be used.

Referring again to the schematic example of FIG. 1, the imaging light 40 illuminates a satellite drop 65 and an ink drop 60 along a light path 45 that is at an angle θ to a plane 26 of the nozzle plate 25. An axis 30 marks a direction along which the ink is jetted (we sometimes say along which the ink falls because often the inkjet head is oriented so that the jetting occurs in a downward direction toward the substrate). The axis 30 is perpendicular to the plane 25 of the nozzle plate 20. The imaging light 40 is reflected from the nozzle surface and captured by the detector 50. Alternatively, the light path may be essentially parallel to the nozzle surface so that light travels directly from the light source to the detector. The detector 50 can include imaging optics such as a zoom lens and an objective lens. The jetted ink feature 60 interrupts the illuminating light 40 so that a shadow of it is projected onto the detector 50. Alternatively, coaxial illumination could be reflected off the jetted ink feature 60 and imaged by the detector 50. Coaxial illumination involves placing a beam splitter in the optics attached to the detector 50 so that light can be directed along the same path that light follows when returning to the detector, though in the opposite direction.

In FIG. 1, the nozzles are arranged in a grid pattern 21 in the nozzle plate 20. However, other arrangements are possible. In some embodiments, each nozzle 20 has a dimension of 22 μm. In some embodiments, the angle θ may be approximately 15°. Depending on the depth of focus of the imaging optics and the angle at which illuminating light is incident, ink jetted from more than one nozzle may be captured in the image, either unintentionally or deliberately. In some embodiments, the detector 50 is a Sony XCD-X710 video camera operated in an external trigger mode. The external trigger mode allows the video camera to be synchronized to the jetting of the ink. Detector 50 can include an Optem Zoom70XL zoom lens and a Mitutoyo M Plan APO 10X objective lens.

To synchronize the jetting to the video camera, signals 13 sent from the waveform generator 12 to the actuators 25 to trigger the jetting of ink are also fed to the video camera, as explained earlier with reference to FIG. 2. These signals 13 cause the camera to begin acquiring image data for each of the successive image frames (e.g., by opening a shutter of the camera to capture light for imaging) a fixed period of time after receiving each of the signals 13. The same signal or a related signal can also be used to trigger the laser to fire a pulse.

In some embodiments, the laser pulse has a pulse duration of 5 ns, and the exposure time of the camera may be set to more than 20 ns or to more than 200 is to allow for the Q-switch delay. In practice, in some implementations, the exposure time may be 1/frame rate which may be ⅕ second or ˜200 ms. In the synchronized mode of operation, the laser pulse can be selectively fired at a time to illuminate jetted ink as it leaves the nozzle 20, and the video camera is timed to capture this image. The exposure time is determined at least in part by the length of the laser pulse. For example, in order to capture the image generated by light from the full laser pulse, the exposure time is set to be longer than the flash of laser pulse. However, in the case of very short laser pulses (e.g., approximately 5 ns), the exposure time of the camera is longer than the laser pulse due to the limit on shutter speeds. The longer exposure time of the camera in comparison to the laser pulse duration is somewhat irrelevant to the image capture, except in situations where the long exposure time of the camera leads to the capture of stray light.

The sequence of images A-S in FIG. 3 of ink being jetted from a nozzle 20 were recorded at an optical magnification of approximately 20× and an exposure that was less than 20 ns each. The frame rate of the imaging was 5 Hz. At this frame rate of imaging, the image of the drops when viewed directly on the video display is not averaged by the latency of the image in the human visual system (e.g., eye or brain). Each image in the sequence is of a different drop generated by a different fire pulse. One can rely on the repeatability of drop formation to study features of the jetted ink this way even though the successive images are not images of the same drop. In some implementations, in which ink is jetted at 15 kHz and the frame rate of imaging is 5 Hz, 3000 drops are fired between images. This repeatability of jetted ink from one firing to another is a property of the piezo inkjet technology.

In this example sequence, the ink 5 was jetted from the nozzle 20 initially as a stream 11 of ink. One or more drops of ink were then formed, for example, at the lower portion 16 of the stream 11. Upon truncation of the top end 304 of the ink stream 11 (also described as the “tail” of the ink stream) at a truncation point 305, a spherical drop 331 was formed at an upper portion 306 of the truncated ink stream 307. One or more satellite ink drops 65 also were formed at the trailing end 308 of the ink stream. The drop size and the drop velocity can be determined in a single image, because the scale of the image and the time it was taken relative to a trigger pulse were known.

Image A was captured before an electrical waveform was applied to the actuator 15 to jet ink from the nozzle 20. Image B captured a volume of ink 302 leaving the nozzle 20. A part 301 of the ink volume depicted as being above the nozzle is an optical reflection of a volume 302 of ink below the nozzle. Images C-D show the volume of ink lengthening into a thinning stream 11 under the influence of the momentum due to the initial velocity of the jetted ink, and the surface tension of the ink. In images E-I, the ink stream continues to lengthen. During that period, a nascent spherical drop 14 begins to form at the lower portion 16 of the ink stream due to the surface tension of the ink, and the initial velocity of the jetted ink.

Following the time at which image I was captured, the lower portion of the ink stream exited the field of view (FOV) of the imaging arrangement. We use the term FOV to include the extent of space that can be captured by the imaging arrangement. In image K, the flow of ink out of nozzle 20 began to terminate and the ink stream became thinner. As shown in image M, the top portion 303 of the ink stream began to acquire a spherical shape. In image N, the ink stream broke up and the upper portion of the ink stream having the spherical shape was terminated from a residual ink stream 320. The top portion of a truncated ink stream 307 continued to become more spherical due to the surface tension of the ink. Image O shows that the residual ink stream 320 broke into droplets, which are termed satellite droplets or mists. Satellite drops in images C and D were from a previous drop ejection event—the small satellite drops travel slowly (they may have close to zero velocity) and take a long time to exit the FOV. Satellite drops are typically swept up by an ink drop in the next drop ejection event. The position of a satellite drop is highly variable and becomes more so the farther out in time from the firing of the ink drop. For example, if ink is jetted at 10 kHz, satellite drops may have been floating about for ˜100 μs. Satellite formation is much less repeatable than the formation of the main drop (e.g., spherical drop 331), and thus, satellite drops typically cannot be tracked from frame to frame in images O-S. A detector having a 1 MHz frame rate would be needed were it to look at the same drop at successive intervals of 1 μs (as in these sequences shown in FIG. 3).

In FIGS. 4A and 4B diffraction affects the images acquired using the arrangement of FIGS. 2 and 3, including a linear lens 360 (e.g., a cylindrical lens). The cylindrical lens 360 (FIG. 2) focuses illuminating light 40 to have a narrower profile along the axis 30 (FIG. 2). The nozzle 20 shown in FIG. 4A has a width of 22 μm. The nozzle 20 is square but is foreshortened in one direction since the illuminating light 40 is incident on it at a shallow angle of, for example, 15 degrees). As a result of the use of a cylindrical lens 360, jetted ink 500 has a sharp outline. The jetted ink 500 has a shape of a smaller upper spherical portion 501 connected by a column of ink 502 to a larger lower spherical portion 503. Depending on the velocity of the jetted ink and its surface tension, the upper and lower spherical portions 501 and 503, and the ink column 502 coalesce to form a substantially spherical drop.

FIG. 4B is the image at the detector when no cylindrical lens is used. The magnification in FIG. 4B is about half that of the magnification in FIG. 4A. The rectangular structure 24 at the top portion is the same nozzle 20 having a length of 22 μm. The bright rim of light 512 on the left side of an ink drop 510 is due to diffraction. The presence of diffraction indicates that further magnification of that image would not be useful for data analysis. The presence of artifacts due to diffraction will increasingly obscure features of the jetted ink at higher magnification.

Other implementations are also within the following claims.

1. An apparatus comprising
a laser to produce a coherent beam to illuminate ink jetted from an orifice of an inkjet, for use in imaging the jetted ink, and
a device to reduce an effect of speckle caused by the coherent beam in the imaging of the jetted ink.

2. The apparatus of claim 1 in which the device to reduce the effect of speckle comprises a device to render the beam at least partly incoherent.

3. The apparatus of claim 1 in which the device to reduce the effect of speckle is configured to alter an aspect of a phase of a wavefront of the coherent beam.

4. The apparatus of claim 3 in which the aspect of the phase of the wavefront that is altered is temporal or spatial or both.

5. The apparatus of claim 1 in which the device to reduce the effect of speckle comprises a diffuser through which the coherent beam is to be passed.

6. The apparatus of claim 1 comprising an element to reduce diffraction effects in the imaging.

7. The apparatus of claim 6 in which the element comprises a lens.

8. The apparatus of claim 5 in which the lens comprises a cylindrical lens.

9. The apparatus of claim 5 in which the lens has an optical axis that is parallel to an axis of the jetted ink.

10. The apparatus of claim 1 in which the laser comprises a Nd:YAG laser.

11. The apparatus of claim 1 comprising a trigger to synchronize the coherent beam with the jetted ink.

12. The apparatus of claim 1 in which the device to reduce the effect of speckle comprises a diffuser.

13. The apparatus of claim 1 comprising a cylindrical lens.

14. The apparatus of claim 13 in which the cylindrical lens comprises a Fresnel lens.

15. The apparatus of claim 1 comprising a video camera for the imaging.

16. The apparatus of claim 1 in which the laser is configured to deliver a flash of the coherent beam that is brief enough to permit imaging, without motion blur, of jetted ink moving at a speed of at least 10 meters/second.

17. The apparatus of claim 1 in which the laser is configured to produce the coherent beam at an intensity that permits imaging of jetted ink that has features of interest that are smaller than 3 micrometers.

18. The apparatus of claim 1 in which the imaging comprises a video.

19. The apparatus of claim 1 in which the imaging comprises a single image.

20. The apparatus of claim 1 in which the imaging comprises a succession of images captured at a frequency of up to 15 Hz.

21. The apparatus of claim 1 in which the imaging comprises optical magnification of up to 20 or more times real life.

22. An apparatus comprising
a laser to produce a coherent beam to illuminate ink jetted from an orifice of an inkjet, for use in imaging the jetted ink, the coherent beam having an intensity that permits imaging of jetted ink that has features of interest that are smaller than 3 micrometers.
a device to reduce an effect of speckle caused by the coherent beam in the imaging of the jetted ink, by rendering the beam at least partly incoherent,
a trigger to synchronize the coherent beam with the jetted ink and to cause a flash of the coherent beam to be brief enough to permit imaging, without motion blur, of jetted ink moving at a speed of at least 10 meters/second, and
a camera for the imaging.

23. A method comprising
jetting ink from an orifice of an inkjet,
applying a coherent beam from a laser to the jetted ink while it is in motion,
imaging the jetted ink while it is in motion, and
reducing an effect of speckle caused by the coherent beam on the imaged jetted ink.

24. The method of claim 23 in which the reducing of the effect of speckle comprises rendering the coherent beam at least partly incoherent.

25. The method of claim 24 in which the reducing of the effect of speckle comprises altering an aspect of a phase of a wavefront of the coherent beam.

26. The method of claim 25 in which the altering comprises altering a temporal or spatial aspect of the phase or both.

27. The method of claim 23 comprising synchronizing a flash of the coherent beam with motion of the jetted ink.

28. The method of claim 23 in which the imaging comprises capturing a single image, a series of images or a video.

29. The method of claim 23 in which the imaging comprises magnifying the jetted ink in the imaging by at least 10 times real life.

30. The method of claim 23 comprising causing a flash of the coherent beam to be brief enough to permit imaging, without motion blur, of jetted ink moving at a speed of at least 10 meters/second.

31. The method of claim 23 comprising producing the coherent beam at a brightness that permits imaging of jetted ink that has features of interest that are smaller than 3 micrometers.
